(19) United States
(12) Patent Application Publication
(10) Pub. No.: US 2026/0093141 A1
(43) Pub. Date: Apr. 2, 2026

(54) DISPLAY DEVICE

(71) Applicant: Japan Display Inc., Tokyo (JP)

(72) Inventor: Tenfu NAKAMURA, Tokyo (JP)

(73) Assignee: Japan Display Inc., Tokyo (JP)

(21) Appl. No.: 19/333,471

(22) Filed: Sep. 19, 2025

(30) Foreign Application Priority Data
Sep. 30, 2024 (JP) 2024-170839

(51) Int. Cl. G02F 1/1334; F21V 8/00

(52) U.S. Cl. CPC G02F 1/1334; G02B 6/0068

(57) ABSTRACT

According to one embodiment, a display device includes a light guide overlaid on a display panel, and a plurality of light-emitting elements. The light guide includes a first portion overlapping a display area and a second portion connected to the first portion. A width of the first portion along a first direction is greater than a width of the second portion, the second portion includes a first side surface extending in a first extending direction different from the first direction and a second direction, and a second side surface extending in a second extending direction different from the first extending direction in plan view. The plurality of light-emitting elements are disposed along the first side surface and the second side surface.

### CROSS-REFERENCE TO RELATED APPLICATIONS

This application is based upon and claims the benefit of priority from Japanese Patent Application No. 2024-170839, filed Sep. 30, 2024, the entire contents of which are incorporated herein by reference.

### FIELD Embodiments described herein relate generally to a display device.

### BACKGROUND

In recent years, display devices comprising a display panel having a polymer dispersed liquid crystal (PDLC) layer, a light source and the like have been proposed. The polymer dispersed liquid crystal layer can switch between a scattering state, in which light is scattered, and a transparent state, in which light is transmitted.

The display device can display images in the scattering state. When the display panel is switched to the transparent state, the user can visually recognize the background through the display panel.

### BRIEF DESCRIPTION OF THE DRAWINGS

FIG. 1 is a diagram showing a configuration example of a display device according to the first embodiment.

FIG. 2 is a cross-sectional view schematically showing a display panel shown in FIG. 1.

FIG. 3 is a plan view schematically showing the display device according to the first embodiment.

FIG. 4 is a side view schematically showing the display device according to the first embodiment.

FIG. 5 is a plan view schematically showing a display device according to a comparative example.

FIG. 6 is a side view schematically showing another example of the display device according to the first embodiment.

FIG. 7 is a plan view schematically showing a display device according to the second embodiment.

FIG. 8 is a plan view schematically showing another example of the display device according to the second embodiment.

FIG. 9 is a plan view schematically showing a display device according to the third embodiment.

FIG. 10 is a plan view schematically showing a display device according to the fourth embodiment.

FIG. 11 is a plan view schematically showing a display device according to the fifth embodiment.

### DETAILED DESCRIPTION

In general, according to one embodiment, a display device includes a liquid crystal layer containing a polymer-dispersed liquid crystal, and switching between a first state in which light entering the liquid crystal layer is transmitted and a second state in which light entering the liquid crystal layer is scattered in accordance with a voltage applied to the liquid crystal layer. The display device includes a display panel including a display area comprising a plurality of pixels, a light guide overlaid on the display panel, and a plurality of light-emitting elements which irradiating light to the light guide. The light guide includes a first portion overlapping the display area and a second portion connected to the first portion, some of the plurality of pixels are disposed in a matrix along a first direction and a second direction orthogonal to the first direction, a width of the first portion along the first direction is greater than a width of the second portion along the first direction, the second portion includes a first side surface extending in a first extending direction different from the first direction and the second direction, and a second side surface extending in a second extending direction different from the first extending direction in plan view, and the plurality of light-emitting elements are disposed along the first side surface and the second side surface.

According to another embodiment, a display device includes a display panel including a display area containing a plurality of pixels, a substrate overlaid on the display panel, comprising a main surface and side surfaces intersecting the main surface, and having light transmittance, and a plurality of light-emitting elements disposed along part of the side surfaces. The substrate includes a non-overlapping area which does not overlap the display panel. The part of the side surfaces includes a first side surface and a second side surface that are located in the non-overlapping area. In plan view, a first extending direction in which the first side surface extends is different from a second extending direction in which the second side surface extends.

With configurations such as described above, it is possible to provide a display device, which can suppress the decrease in display quality.

Each of the embodiments will now be described hereinafter with reference to the accompanying drawings. Note that the disclosure is merely an example, and proper changes within the spirit of the invention, which are easily conceivable by a skilled person, are included in the scope of the invention as a matter of course.

In addition, as to the drawings, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

Note that, in order to make the descriptions more easily understandable, some of the drawings illustrate an X axis, a Y axis and a Z axis orthogonal to each other. A direction along the X axis is referred to as a first direction X, a direction along the Y axis is referred to as a second direction Y and a direction along the Z axis is referred to as a third direction Z. Further, viewing the constitutional elements parallel to the Z direction is referred to as plan view.

In each of the embodiments, as an example of the display device, a highly light-transmitting transparent display device in which using polymer-dispersed liquid crystals are applied(, which is the so-called transparent display device) is disclosed.

Note that the configurations disclosed in each embodiment may be applied to other types of display devices as well.

### First Embodiment

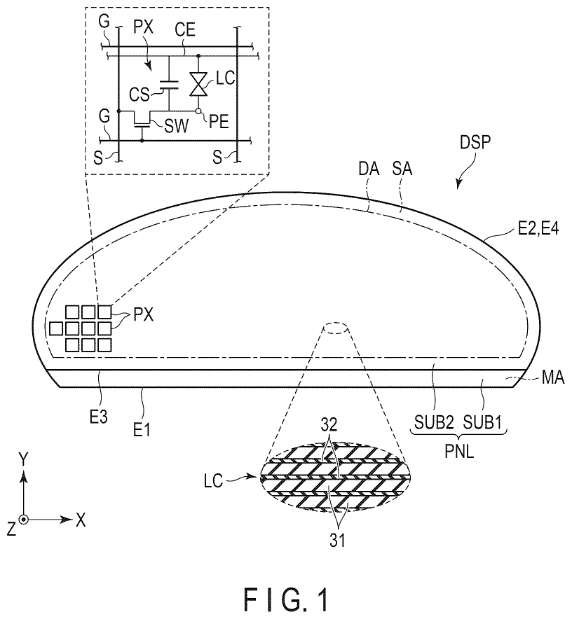

FIG. 1 is a diagram showing a configuration example of a display device DSP according to this embodiment. The display device DSP comprises a display panel PNL. The display panel PNL comprises a first substrate SUB1 and a second substrate SUB2 stacked along the third direction Z. The first substrate SUB1 and the second substrate SUB2 are formed into flat plates parallel to the X-Y plane defined by the X axis and the Y axis.

In the example shown in FIG. 1, the first substrate SUB1 and the second substrate SUB2 have a shape that is elongated along the first direction X in plan view. Specifically, the first substrate SUB1 and the second substrate SUB2 have an elliptical shape in which one end portion of the short axis side is cut off.

Note that the shape of the first substrate SUB1 and the second substrate SUB2 is not limited to that of this example, but the first substrate SUB1 and the second substrate SUB2 may have an elongated oval shape, a rectangular shape, or any other shape. From another perspective, the first substrate SUB1 and the second substrate SUB2 have a symmetrical shape having a symmetrical axis extending along the second direction Y.

The first substrate SUB1 has a side surface E1 and a side surface E2. The side surface E1 has a linear shape extending along the first direction X.

The side surface E2 is connected to both ends of the side surface E1. The side surface E2 has a curved shape. Specifically, the side surface E2 is formed so as to expand outward in the first direction X and in a direction opposite to the first direction X relative to the side surface E1.

The second substrate SUB2 has a side surface E3 and a side surface E4. The side surface E3 has a linear shape extending along the first direction X.

The side surface E4 has a shape similar to that of the side surface E3. The display panel PNL has a curved portion in plan view. The side surface E4 is connected to both ends of the side surface E3. The side surface E4 overlaps the side surface E2 along the third direction Z.

The width of the first substrate SUB1 along the second direction Y is greater than the width of the second substrate SUB2 along the second direction Y.

The first substrate SUB1 has a mounting area MA formed in a portion protruding further from the second substrate SUB2 in the direction opposite to the second direction Y.

The mounting area MA corresponds to the region of the first substrate SUB1, which does not overlap the second substrate SUB2. In other words, the mounting area MA corresponds to the region between the side surface E1 and the side surface E3 in the second direction Y. On the mounting area MA, integrated circuits and a flexible circuit board not shown in the figure are mounted.

The display panel PNL includes a display area DA that displays images and a peripheral area SA surrounding the display area DA. The display area DA and the peripheral area SA are both formed in the region where the first substrate SUB1 and the second substrate SUB2 overlap each other. The display area DA comprises a plurality of pixels PX arranged in a matrix along the first direction X and the second direction Y.

The display panel PNL further comprises a liquid crystal layer LC sealed between the first substrate SUB1 and the second substrate SUB2. As shown schematically in the enlarged view at the bottom of FIG. 1, the liquid crystal layer LC is constituted by a polymer dispersed liquid crystal containing polymers 31 and liquid crystal molecules 32.

In one example, the polymers 31 are liquid crystal polymers. The polymers 31 are formed into strips extending along the first direction X and arranged at intervals along the second direction Y.

The liquid crystal molecules 32 are dispersed in the gaps between the polymers 31 and arranged such that their longitudinal axes are aligned along the first direction X.

Each of the polymers 31 and liquid crystal molecules 32 exhibits optical anisotropy or refractive index anisotropy. The response of the polymers 31 to an electric field is lower than that of the liquid crystal molecules 32. In one example, the alignment direction of the polymers 31 remains substantially unchanged regardless of the presence or absence of an electric field. In contrast, the alignment direction of the liquid crystal molecules 32 changes in response to the voltage applied to the liquid crystal layer LC.

When no voltage is being applied to the liquid crystal layer LC, the optical axes of the polymers 31 and the liquid crystal molecules 32 are parallel to each other, and light entering the liquid crystal layer LC passes through the liquid crystal layer LC without being substantially scattered (transparent state).

When a voltage is being applied to the liquid crystal layer LC, the optical axes of the polymers 31 and the liquid crystal molecules 32 intersect with each other, and the light entering the liquid crystal layer LC is scattered within the liquid crystal layer LC (scattering state). In this way, the display device DSP can switch between the transparent state and the scattering state according to on the applied voltage.

As shown enlarged in the upper part of FIG. 1, the display area DA has a plurality of scanning lines G and a plurality of signal lines S disposed thereon. The scanning lines G each extend along the first direction X and are aligned along the second direction Y. The signal lines S each extend along the second direction Y and are aligned along the first direction X. The signal lines S intersect with the scanning lines G.

Each of the pixels PX comprises a switching element SW, a pixel electrode PE, a common electrode CE, and a capacitor CS. The switching element SW is constituted, for example, by a thin film transistor (TFT) and electrically connected to a respective one of the scanning lines G and a respective one of the signal lines S. The pixel electrode PE is electrically connected to the switching element SW.

The liquid crystal layer LC (in particular, liquid crystal molecules 32) is driven by an electric field generated between the pixel electrode PE and the common electrode CE. The capacitor CS is formed between an electrode at the same potential as that of the common electrode CE and an electrode at the same potential as that of the pixel electrode PE.

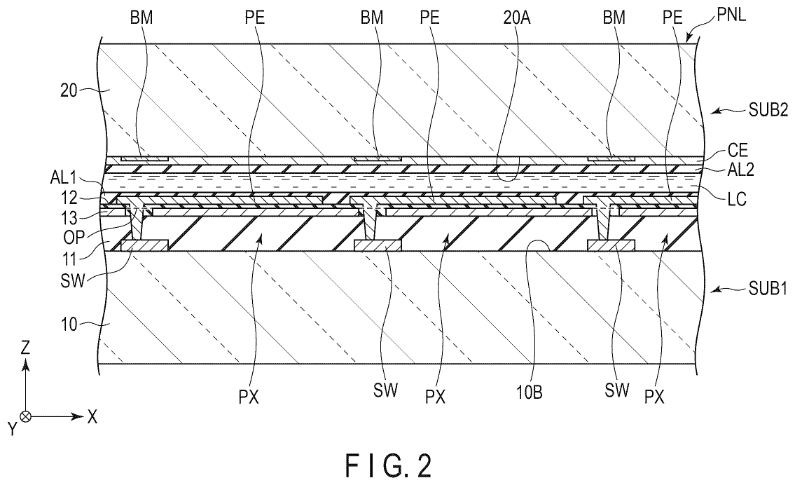

FIG. 2 is a cross-sectional view schematically illustrating the display panel PNL shown in FIG. 1. The first substrate SUB1 comprises a first transparent substrate 10, insulating films 11 and 12, capacitive electrodes 13, switching elements SW, pixel electrodes PE, and an alignment film AL1.

Although not shown in the figure, the first substrate SUB1 further includes scanning lines G and signal lines S as shown in FIG. 1. The switching elements SW are arranged on the main surface 10B of the first transparent substrate 10. The main surface 10B faces the second substrate SUB2. The insulating film 11 covers the switching elements SW. The capacitive electrodes 13 is located between the insulating film 11 and insulating film 12.

In the example illustrated, the insulating film 11 and each capacitive electrode 13 are disposed over the entire surface of each pixel PX, but the configuration is not limited to that of this example. If suffices if the insulating film 11 is disposed to cover at least the switching elements SW, the scanning lines G, and the signal lines S.

The capacitive electrodes 13 may each be formed in a grid pattern along the respective one of the scanning lines G and the respective one of the signal lines S. The pixel electrodes PE are disposed the insulating film 12 each for each respective one of the pixels PX. The pixel electrodes PE are electrically connected to the switching elements SW, respectively, through apertures OP of the capacitive electrodes 13. The pixel electrodes PE overlap the capacitive electrodes 13 while interposing the insulating film 12 therebetween, and thus the capacitors CS of the pixels PX are respectively formed. The alignment film AL1 covers the pixel electrodes PE.

The second substrate SUB2 comprises a second transparent substrate 20, light-shielding layers BM, a common electrode CE, and an alignment film AL2. The second transparent substrate 20 faces the first transparent substrate 10 along the third direction Z.

The light-shielding layers BM and the common electrode CE are disposed on the main surface 20A of the second transparent substrate 20. The main surface 20A faces the first transparent substrate 10. The light-shielding layers BM are located, for example, directly above the switching elements SW, the scanning lines G, and the signal lines S (not shown), respectively.

The common electrode CE faces the pixel electrodes PE while interposing the liquid crystal layer LC therebetween in the third direction Z. The common electrode CE is disposed over multiple pixels PX and directly covers the light-shielding layers BM. The common electrode CE is electrically connected to the capacitive electrodes 13 and is at the same potential as that of the capacitive electrode 13. The alignment film AL2 covers the common electrode CE.

The liquid crystal layer LC is located between the first transparent substrate 10 and the second transparent substrate 20 and is in contact with the alignment films AL1 and AL2. In the first substrate SUB1, the insulating film 11, insulating film 12, capacitive electrodes 13, switching elements SW, pixel electrodes PE, alignment film AL1, scanning lines G, and signal lines S are located between the first transparent substrate 10 and the liquid crystal layer LC. In the second substrate SUB2, the light-shielding layers BM, common electrode CE, and alignment film AL2 are located between the second transparent substrate 20 and the liquid crystal layer LC.

The first transparent substrate 10 and the second transparent substrate 20 are insulating substrates such as glass substrates or plastic substrates. The insulating film 11 is formed from a transparent insulating material such as silicon oxide, silicon nitride, silicon oxynitride, or acrylic resin.

For example, the insulating film 11 includes an inorganic insulating film and an organic insulating film. The insulating film 12 is an inorganic insulating film such as silicon nitride. The capacitive electrodes 13, pixel electrodes PE, and common electrode CE are transparent electrodes formed from a transparent conductive material such as indium tin oxide (ITO) or indium zinc oxide (IZO). The light-shielding layers BM are conductive layers having a resistance lower than that of the common electrode CE.

In one example, the light-shielding layer BM is formed from an opaque metallic material such as molybdenum, aluminum, tungsten, titanium, or silver. The alignment films AL1 and AL2 are horizontal alignment films having an alignment restriction force substantially parallel to the X-Y plane. In one example, the alignment films AL1 and AL2 are subjected to alignment treatment along the first direction X. Note that the alignment treatment may be a rubbing process or a photo-alignment treatment.

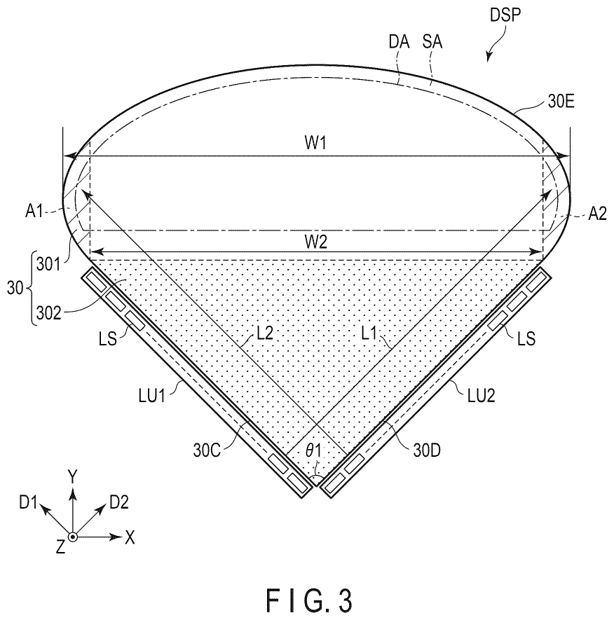

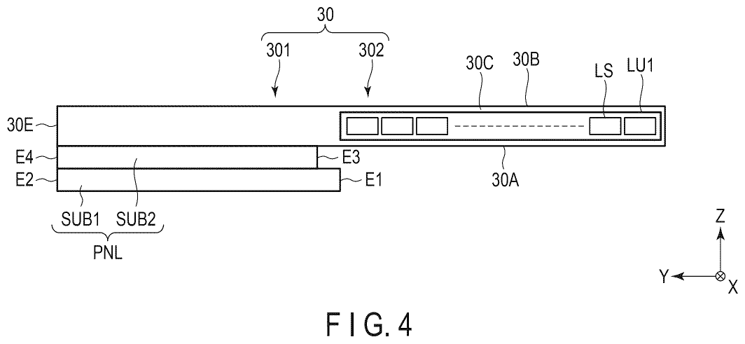

FIG. 3 is a plan view schematically showing the display device DSP according to this embodiment. FIG. 4 is a side view schematically showing the display device DSP according to this embodiment. In FIG. 4, the display device DSP is viewed along the first direction X.

The display device DSP further comprises a light guide 30 having light transmittance, as shown in FIGS. 3 and 4. The light guide 30 is a transparent substrate, such as a glass substrate, but may as well be an insulating substrate such as a plastic substrate.

The thickness of the light guide 30, as shown in the example of FIG. 4, is greater than the thickness of the first substrate SUB1 and the second substrate SUB2. Here, the thickness refers to the distance along the third direction Z. In one example, the light guide 30 has a thickness that is two times or more than the thickness of the first substrate SUB1 and the second substrate SUB2.

The size of the light guide 30 in plan view is larger than the size of the display panel PNL in plan view. The light guide 30 includes a first portion 301 that overlaps the display panel PNL and a second portion 302 connected to the first portion 301. The first portion 301 and the second portion 302 are formed, for example, to be integrated as one body. Note that the first portion 301 and the second portion 302 may be formed from different members.

The first portion 301 includes a portion that overlaps the display area DA in plan view. In this embodiment, the size of the display panel PNL in plan view is equal to the size of the first portion 301. In this embodiment, the second portion 302 corresponds to the portion that does not overlap the display panel PNL (non-overlapping area). In FIG. 3, the second portion 302 are marked with dots.

The second portion 302 has an approximately triangular shape in plan view. The width of the second portion 302 in the first direction X decreases at a constant ratio as the location is farther away from the first portion 301 (in a direction opposite to the second direction Y).

The light guide 30 has a main surface 30A, a main surface 30B on an opposite side to the main surface 30A, and side surfaces 30C, 30D, and 30E connecting the main surfaces 30A and 30B, as shown in FIGS. 3 and 4. The side surfaces 30C, 30D, and 30E are surfaces intersecting the main surfaces 30A and 30B.

In this embodiment, the side surface 30C is an example of a first side surface, and the side surface 30D is an example of a second side surface. The main surfaces 30A and 30B are parallel to the X-Y plane. The main surface 30A faces the second substrate SUB2. The light guide 30 is, for example, adhered to the second transparent substrate 20 by an adhesive layer (not shown).

The side surfaces 30C and 30D are included in the second portion 302, and the side surface 30E is included in the first portion 301. The side surfaces 30C and 30D extend in directions different from the first direction X and the second direction Y, respectively, in plan view.

The side surfaces 30C and 30D extend in directions different from each other. Here, the direction that intersects the second direction Y at an acute angle in a counterclockwise direction is defined as a direction D1, and the direction that intersects the second direction Y at an acute angle in a clockwise direction is defined as a direction D2. In this embodiment, the direction D1 is an example of the first extending direction, and the direction D2 is an example of the second extending direction.

Note that the angle made between the second direction Y and the direction D1, and the angle made between the second direction Y and the direction D2 may be the same, but the angle between the second direction Y and the direction D1 may be different from the angle between the second direction Y and the direction D2.

The side surface 30C extends along the direction D1, and the side surface 30D extends along the direction D2. For example, the side surface 30C overlaps a tangent passing through one end of the side surface 30E, and the side surface 30D overlaps a tangent passing through the other end of the side surface 30E. In the example shown in FIG. 3, the second portion 302 is formed up to the position where these tangents intersect with each other. That is, the side surface 30C is formed so as to intersect the side surface 30D.

The length of the side surface 30C is, for example, equal to the length of the side surface 30D. In the example shown in FIG. 3, the side surfaces 30C and 30D both extend in a linear fashion. One end of the side surface 30C is connected to one end of the side surface 30D. The angle θ1 made between the side surface 30C and side surface 30D is, for example, 90 degrees, but the configuration is not limited to that of this example.

The side surface 30E is formed in a curved shape and connects the side surface 30C and side surface 30D to each other. In the example shown in FIG. 4, the side surface 30E overlaps a side surface E2 of the first substrate SUB1 and a side surface E4 of the second substrate SUB2.

The width W1 of the first portion 301 in the first direction X is greater than the width W2 of the second portion 302 in the first direction X. The width W1 is the maximum width of the first portion 301 in the first direction X, and the width W2 is the maximum width of the second portion 302 in the first direction X. Further, the width W1 corresponds to the width of the display panel PNL in the first direction X.

The first portion 301 has areas A1 and A2 (outer areas) located on respective outer sides of the second portion 302 in both the first direction X and the direction opposite to the first direction X. In FIG. 3, the areas A1 and A2 are marked with diagonal lines.

The width of the areas A1 and A2 corresponds to the difference between the width W1 and the width W2. The areas A1 and A2 overlap the display area DA.

The display area DA has a width greater than the width W2 of the second portion 302 along the first direction X.

The display device DSP further comprises light source units LU1 and LU2. The light source unit LU1 is disposed along the side surface 30C (direction D1), and the light source unit LU2 is disposed along the side surface 30D (direction D2).

The light source unit LU1 comprises a plurality of light-emitting elements LS disposed along the side surface 30C. The light source unit LU2 comprises a plurality of light-emitting elements LS disposed along the side surface 30D. The light-emitting elements LS disposed along the side surface 30C (first side surface) and the side surface 30D (second side surface) are an example of the first group of light-emitting elements. From another perspective, the light-emitting elements LS do not face the side surfaces other than the side surfaces 30C and 30D.

The light-emitting elements LS emit light toward the side surfaces 30C and 30D. In the example shown in FIG. 3, the light-emitting surfaces of the light-emitting elements LS of the light source unit LU1 face the direction D2, and the light-emitting surfaces of the light-emitting elements LS of the light source unit LU2 face the direction D1.

From another perspective, at least one of the light-emitting elements LS of the light source unit LU1 has its light-emitting surface that faces the area A2, and at least one of the light-emitting elements LS of the light source unit LU2 has its light-emitting surface that faces the area A1.

In other words, the area A2 is located in the normal direction of the light-emitting surface of at least one of the light-emitting elements LS of the light source unit LU1, and the area A1 is located in the normal direction of the light-emitting surface of at least one of the light-emitting elements LS of the light source unit LU2.

For example, the light-emitting elements LS include light-emitting elements that emit red light, light-emitting elements that emit green light, and light-emitting elements that emit blue light. These light-emitting elements may be disposed along the directions D1 and D2, or may be stacked along the third direction Z.

As the light-emitting elements LS, light-emitting diodes (LEDs) may be used. Note that, between the light source unit LU1 and the side surface 30C, and between the light source unit LU2 and the side surface 30D, light guides such as prism lenses may be further disposed.

Here, the path of light L1 emitted from the light-emitting elements LS of the light source unit LU1 will be described. The light L1 emitted from the light-emitting elements LS enters the side surface 30C. The light proceeds from the second portion 302 to the first portion 301 while being totally reflected repeatedly between the main surface 30B and the main surface 30A of the light guide 30.

Of the light having reached the first portion 301, the light component traveling toward the main surface 30A proceeds as follows with respect to pixels PX in the transparent state and the scattered state. First, in the vicinity of pixels PX in the transparent state, the light is not substantially scattered in the liquid crystal layer LC. Therefore, the light does not substantially leak out of the light guide 30 and the first transparent substrate 10.

On the other hand, in the vicinity of pixels PX in the scattered state, the light is scattered in the liquid crystal layer LC. This scattered light is emitted from the light guide 30 and the first transparent substrate 10 and is visible to the user as the displayed image. By specifying in stepwise the voltage applied to the pixel electrodes PE within a predetermined range, it is also possible to achieve gradation expression of the scattering degree (brightness). Similarly, the light L2 emitted by the light-emitting elements LS of the light source unit LU2 as well proceeds inside the light guide 30 and the display panel PNL.

Note that in the vicinity of pixels PX in the transparent state, external light entering the light guide 30 and the first transparent substrate 10 passes through the liquid crystal layer LC without being substantially scattered. That is, when the display panel PNL is viewed from the light guide 30 side, the background on the first transparent substrate 10 side is visible, and when the display panel PNL is viewed from the first transparent substrate 10 side, the background on the light guide 30 side is visible.

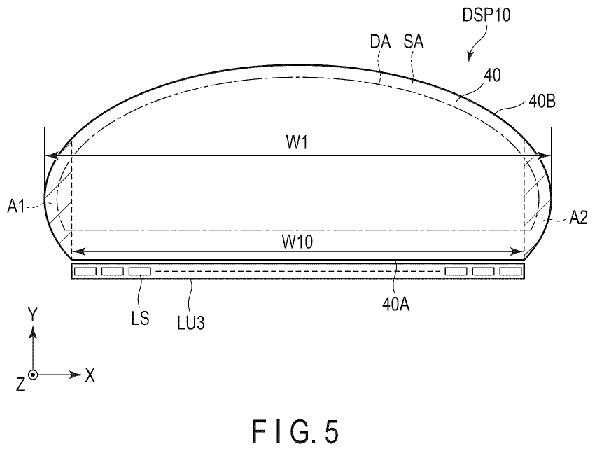

FIG. 5 is a plan view schematically showing a display device DSP10 according to a comparative example. The display device DSP10 comprises a display panel PNL as in the case of this embodiment. The light guide 40 of the display device DSP10 has a size equal to that of the display panel PNL in plan view. In other words, the light guide 40 corresponds to the first portion 301 of the light guide 30 in this embodiment.

The light guide 40 has side surfaces 40A and 40B. The side surface 40A has a linear shape extending in the first direction X. The side surface 40A overlaps the side surface E1 of the first substrate SUB1 in the third direction Z. The side surface 40B is connected to both ends of the side surface 40A. The side surface 40B overlaps the side surface E2 of the first substrate SUB1 and the side surface E4 of the second substrate SUB2.

The display device DSP10 further comprises a light source unit LU3. The light source unit LU3 is disposed along the side surface 40A (first direction X). The light source unit LU3 comprises a plurality of light-emitting elements LS disposed along the side surface 40A.

The light-emitting elements LS of the light source unit LU3 face toward the second direction Y. The light-emitting elements LS of the light source unit LU3 emit light toward the side surface 40A. The light emitted from the light source unit LU3 proceeds inside the light guide 40 toward the second direction Y.

The width W1 of the light guide 40 along the first direction is greater than the width W10 of the side surface 40A along the first direction X. With this configuration, the light guide 40 has areas A1 and A2, which are located on outer sides of the side surface 40A in the first direction X and in the direction opposite to the first direction X, as in the case of the embodiment.

The areas A1 and A2 are areas where the light emitted from the light source unit LU3 is difficult to enter. Therefore, the brightness in the areas A1 and A2 is likely to be lower compared to other areas. This may cause a decrease in display quality.

In this embodiment, as shown in FIG. 3, the light L1 emitted from the light-emitting elements LS of the light source unit LU1 easily enters the area A2, and the light L2 emitted from the light-emitting elements LS of the light source unit LU2 easily enters the area A1.

Specifically, the light guide 30 has side surfaces 30C and 30D in the second portion 302. The side surfaces 30C and 30D extend in directions different from the first direction X and the second direction Y. The light-emitting elements LS of the light source units LU1 and LU2 emit light toward the side surfaces 30C and 30D, respectively.

The light L1 emitted by the light-emitting elements LS of the light source unit LU1 can enter the area A2 of the first portion 301 through the second portion 302 from the side surface 30C. The light L2 emitted by the light-emitting elements LS of the light source unit LU2 can enter the area A1 of the first portion 301 through the second portion 302 from the side surface 30D. That is, the second portion 302 functions as a light-guiding layer that allows light to enter the areas A1 and A2.

As described above, light from the light source units LU1 and LU2 can enter the areas A1 and A2, and therefore the brightness in the areas A1 and A2 does not easily decrease. As a result, the uniformity of brightness in the first portion 301 can be improved.

Even when the areas A1 and A2 overlap the display area DA, the uniformity of brightness in the display area DA can be improved. As a result, degradation in display quality of the display device DSP can be suppressed.

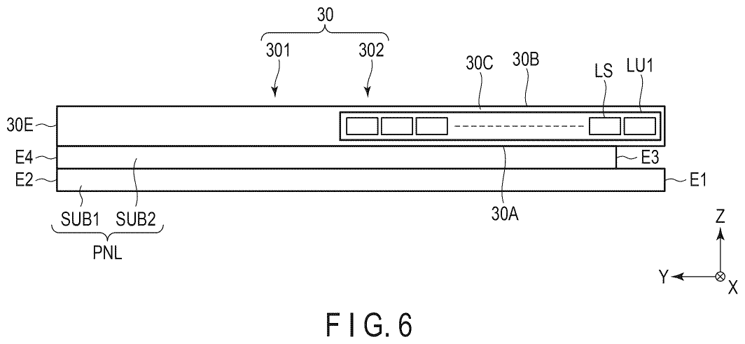

Note that the shape of the display panel PNL is not limited to that of the example discussed above. FIG. 6 is a side view schematically showing another example of the display device DSP according to this embodiment. The display panel PNL may have the same size as that of the light guide 30, as shown in FIG. 6. In this case, the second portion 302 of the light guide 30 overlaps the display panel PNL. With this configuration, the intensity of the display device DSP with respect to the third direction Z can be increased.

In this embodiment, the first portion 301 has both the areas A1 and A2, but it suffices if the first portion 301 has an area located on an outer side of the second portion 302 (outer area) in at least one of the first direction X and the direction opposite to the first direction X.

In this embodiment, an example is disclosed in which the width of the display area DA along the first direction X is greater than the width W2 of the second portion 302 along the first direction X. But the width of the display area DA along the first direction X may as well be less than the width W2 of the second portion 302 along the first direction X.

With the display device DSP configured as described above, degradation of display quality can be suppressed.

Next, other embodiments will be described. For the configuration of the following embodiments, the parts not specifically referred to can be applied from those of the first embodiment.

### Second Embodiment

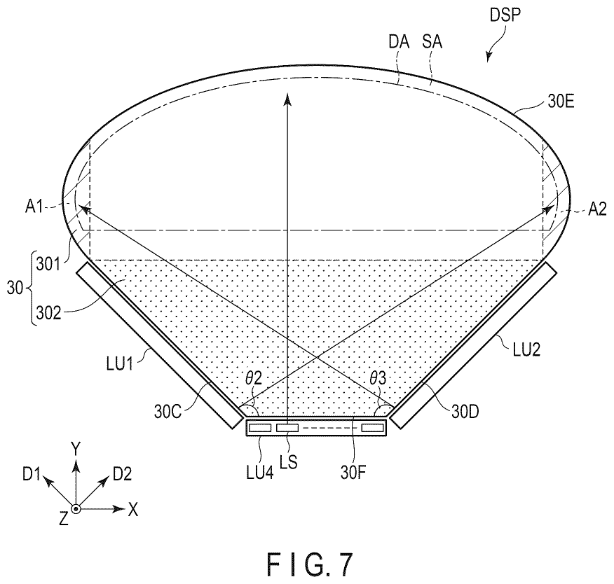

FIG. 7 is a plan view schematically showing a display device DSP according to this embodiment. In this embodiment, the shape of the second portion 302 of the light guide 30 is different from that of the first embodiment. Specifically, the second portion 302 has an approximately trapezoidal shape.

The side surface 30C is spaced apart from the side surface 30D. The light guide 30 further has a side surface 30F in the second portion 302. The side surface 30F is located between the side surface 30C and side surface 30D. In this embodiment, the side surface 30C is an example of the first side surface, the side surface 30D is an example of the second side surface, and the side surface 30F is an example of the third side surface. The side surface 30F connects the side surface 30C and side surface 30D to each other. In the example shown in FIG. 7, the side surface 30F extends along the first direction X.

As shown in FIG. 7, the angle made between the side surface 30F and the side surface 30C is defined as an angle θ2, and the angle made between the side surface 30F and the side surface 30D is defined as an angle θ3. In this embodiment, the angle θ2 is equal to the angle θ3. Further, the angles θ2 and θ3 are greater than 90 degrees and less than 180 degrees. In other words, the angles θ2 and θ3 are obtuse angles.

The display device DSP further comprises a light source unit LU4. The light source unit LU4 is disposed along the side surface 30F (first direction X). The light source unit LU4 includes a plurality of light-emitting elements LS disposed along the side surface 30F. The light-emitting elements LS disposed along the side surface 30F (third side surface) are an example of the second light-emitting element group.

The light-emitting elements LS emit light toward the side surface 30F. In the example shown in FIG. 7, the light-emitting surfaces of the light-emitting elements LS of the light source unit LU4 are directed toward the second direction Y.

In this embodiment, advantageous effects similar to those of the first embodiment can be achieved. In this embodiment, the light source unit LU4 is provided to emit light toward the second direction Y. With this configuration, the amount of light proceeding toward directions other than the directions D1 and D2 (for example, the second direction Y) increases, and therefore the brightness of the area on the opposite side to that where light enters can be further improved. Therefore, it is possible to further suppresses a decrease in display quality.

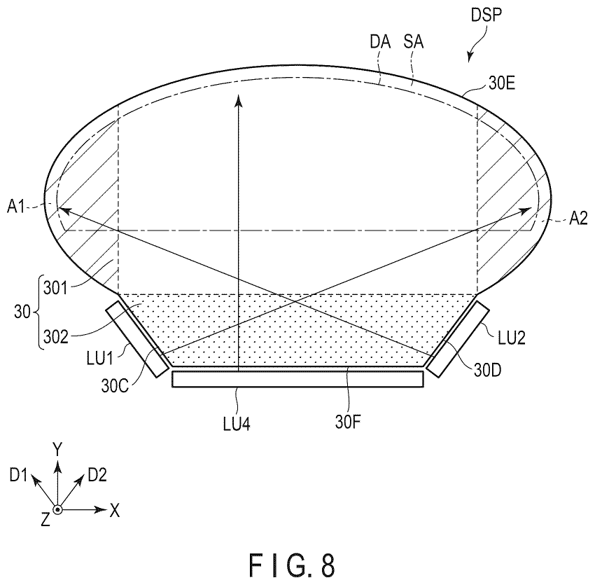

Note that the difference between the width W1 of the first portion 301 along the first direction X and the width W2 of the second portion 302 along the first direction X may be greater than that of the example shown in FIG. 7. FIG. 8 is a plan view schematically showing another example of the display device DSP according to this embodiment.

In this embodiment as well, at least one of the light-emitting elements LS of the light source unit LU1 has its light-emitting surface facing the area A2, and at least one of the light-emitting elements LS of the light source unit LU2 has its light-emitting surface facing the area A1. With this configuration, even with the shape of the light guide 30 shown in FIG. 8, light can be made to enter the areas A1 and A2.

### Third Embodiment

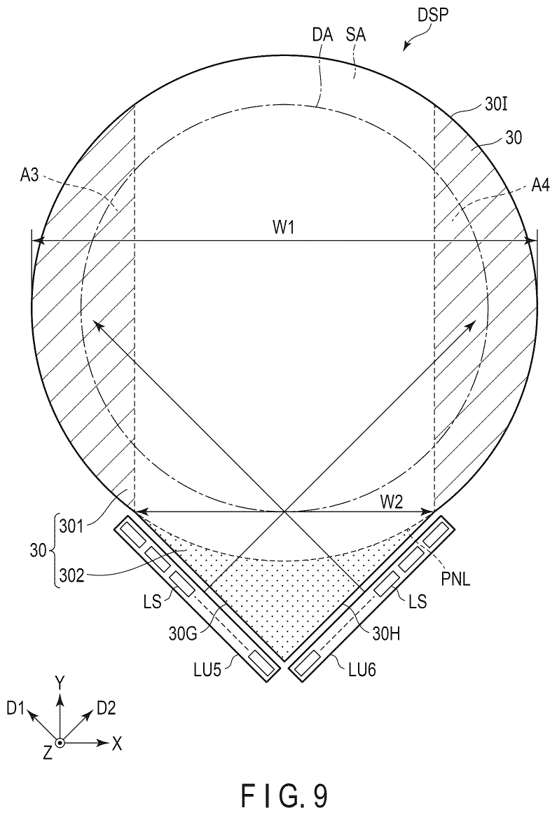

FIG. 9 is a plan view schematically showing a display device DSP according to this embodiment. In this embodiment, the shapes of the display panel PNL and the light guide 30 are different from those in the first embodiment. In this embodiment, the display panel PNL has a circular shape. The display area DA as well has a circular shape.

The light guide 30 overlaps the entire display panel PNL. The light guide 30 has a first portion 301 that overlaps the display panel PNL and a second portion 302 connected to the first portion 301. The width W1 of the first portion 301 along the first direction X is greater than the width W2 of the second portion 302 along the first direction X.

The light guide 30 has side surfaces 30G, 30H, and 30I. In this embodiment, the side surface 30G is an example of the first side surface, and the side surface 30H is an example of the second side surface. The side surfaces 30G and 30H are included in the second portion 302, and the side surface 30I is included in the first portion 301. The side surface 30G extends along the direction D1, and the side surface 30H extends along the direction D2. The length of the side surface 30G is, for example, equal to the length of the side surface 30H.

In the example shown in FIG. 9, the side surfaces 30G and 30H both extend in a linear manner. The side surface 30I is formed into an arc shape and connects the side surface 30G and side surface 30H to each other. The side surface 30I is formed so as to expand in the first direction X and in the opposite direction of the first direction X further from the side surfaces 30G and 30H.

The display device DSP further comprises light source units LU5 and LU6. The light source unit LU5 is disposed along the side surface 30G, and the light source unit LU6 is disposed along the side surface 30H.

The light source unit LU5 comprises a plurality of light-emitting elements LS disposed along the side surface 30G. The light source unit LU6 comprises a plurality of light-emitting elements LS disposed along the side surface 30H. The light-emitting elements LS emit light toward the side surfaces 30G and 30H. The light-emitting elements LS disposed along the side surface 30G (first side surface) and the side surface 30H (second side surface) are an example of the first light-emitting element group.

The first portion 301 has areas A3 and A4 (outer areas) that are provided on outer sides of the second portion 302 farther therefrom in both the first direction X and the direction opposite to the first direction X. In FIG. 9, the areas A3 and A4 are indicated by diagonal lines. The areas A3 and A4 overlap, for example, the display area DA.

At least one of the light-emitting elements LS of the light source unit LU5 has its light-emitting surface facing the area A4, and at least one of the light-emitting elements LS of the light source unit LU6 has its light-emitting surface facing the area A3.

In this embodiment, advantageous effects similar to those of the first embodiment can be obtained. In this embodiment, the light emitted by the light-emitting elements LS of the light source unit LU5 enters the area A4, and the light emitted by the light-emitting elements LS of the light source unit LU6 enters the area A3. As a result, the brightness in the areas A3 and A4 does not easily decrease. Therefore, the uniformity of brightness in the first portion 301 can be improved.

### Fourth Embodiment

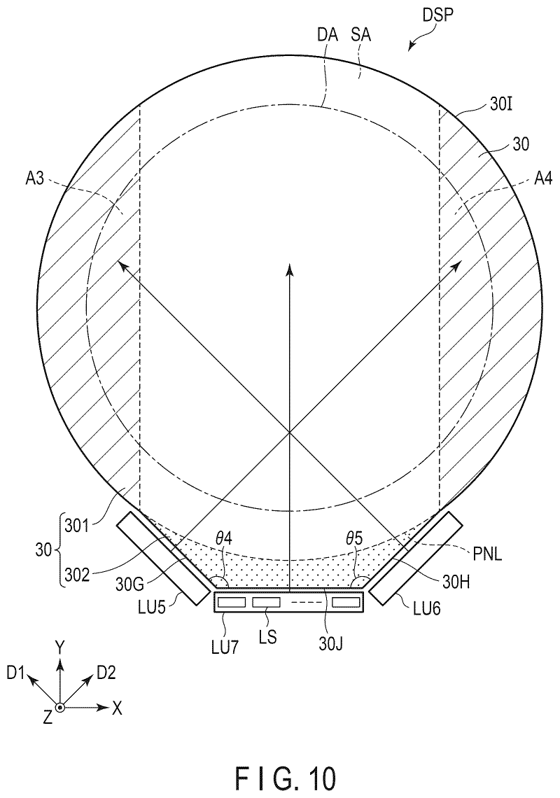

FIG. 10 is a plan view schematically showing a display device DSP according to this embodiment. In this embodiment, the shapes of the second portion 302 of the light guide 30 are different from those of the third embodiment.

The light guide 30 further has a side surface 30J in the second portion 302. In this embodiment, the side surface 30G is an example of the first side surface, the side surface 30H is an example of the second side surface, and the side surface 30J is an example of the third side surface. The side surface 30J connects the side surface 30G and the side surface 30H to each other. In the example shown in FIG. 10, the side surface 30J extends along the first direction X.

As shown in FIG. 10, the angle made between the side surface 30G and the side surface 30J is defined as an angle θ4, and the angle made between the side surface 30H and the side surface 30J is defined as an angle θ5. In this embodiment, the angle θ4 is equal to the angle θ5. Further, the angles θ4 and θ5 are greater than 90 degrees and less than 180 degrees.

The display device DSP further comprises a light source unit LU7. The light source unit LU7 is disposed along the side surface 30J (first direction X). The light source unit LU7 comprises a plurality of light-emitting elements LS disposed along the side surface 30J. The light-emitting elements LS emit light toward the side surface 30J. The light-emitting elements LS disposed along the side surface 30J (third side surface) are an example of the second light-emitting element group. In the example shown in FIG. 10, the light-emitting surfaces of the light-emitting elements LS of the light source unit LU7 are directed toward the second direction Y.

In this embodiment as well, advantageous effects similar to those of the third embodiment can be obtained. According to this embodiment, there is further provided a light source unit LU7 configured to emit light toward the second direction Y. With this configuration, the amount of light proceeding toward directions other than the directions D1 and D2 (for example, the second direction Y) increases, and therefore the brightness of the area on the opposite side to that where light enters can be further improved. Therefore, it is possible to further suppresses a decrease in display quality.

### Fifth Embodiment

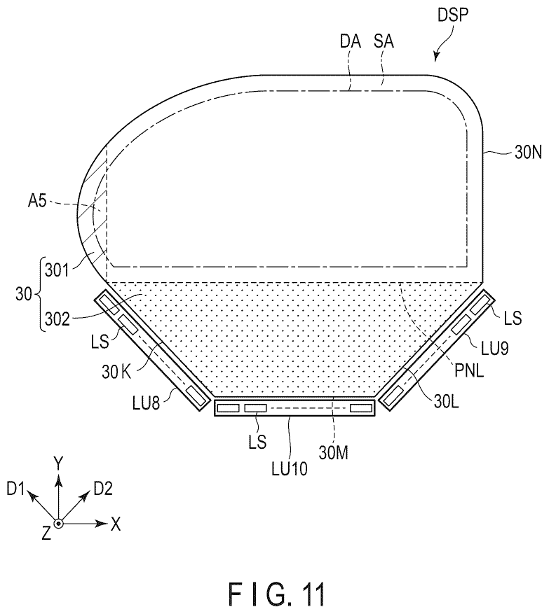

FIG. 11 is a plan view schematically showing a display device DSP according to this embodiment. In this embodiment, the shapes of the display panel PNL and the light guide 30 are different from those of the first embodiment. In this embodiment, the display panel PNL has a shape that is elongated along the first direction X in plan view. The display panel PNL, for example, has a shape that is not line-symmetric.

The light guide 30 overlaps the entire display panel PNL. The light guide 30 has a first portion 301 that overlaps the display panel PNL and a second portion 302 connected to the first portion 301. The width W1 of the first portion 301 along the first direction X is greater than the width W2 of the second portion 302 along the first direction X.

The light guide 30 has side surfaces 30K, 30L, 30M, and 30N. In this embodiment, the side surface 30K is an example of the first side surface, the side surface 30L is an example of the second side surface, and the side surface 30M is an example of the third side surface. The side surfaces 30K, 30L, and 30M are included in the second portion 302, and the side surface 30N is included in the first portion 301.

The side surface 30K extends along the direction D1, the side surface 30L extends along the direction D2, and the side surface 30M extends along the first direction X. The length of the side surface 30K is, for example, equal to the length of the side surface 30L.

In the example shown in FIG. 11, the side surfaces 30K and 30L both extend in a linear line. The side surface 30M extends along the first direction X and connects the side surfaces 30K and 30L to each other. The side surface 30N includes a linear portion and a curved portion, and connects the side surface 30K and side surface 30L to each other. The side surface 30N is formed so as to expand in the direction opposite to the first direction X farther from the side surface 30K.

The display device DSP further comprises light source units LU8, LU9, and LU10. The light source unit LU8 is disposed along the side surface 30K, the light source unit LU9 is disposed along the side surface 30L, and the light source unit LU10 is disposed along the side surface 30M.

The light source unit LU8 comprises a plurality of light-emitting elements LS disposed along the side surface 30K. The light source unit LU9 comprises a plurality of light-emitting elements LS disposed along the side surface 30L. The light source unit LU10 comprises a plurality of light-emitting elements LS disposed along the side surface 30M. The light-emitting elements LS emit light toward the side surfaces 30K, 30L, and 30M, respectively. The light-emitting elements LS disposed along the side surface 30K (first side surface) and side surface 30L (second side surface) are an example of the first light-emitting element group. The light-emitting elements LS disposed along the side surface 30M (third side surface) are an example of the second light-emitting element group.

The first portion 301 has an area A5 provided on an outer side of the second portion 302 (outer area) in the direction opposite to the first direction X. In FIG. 11, the area A5 is marked with diagonal lines. The area A5, for example, overlaps the display area DA. At least one of the light-emitting elements LS of the light source unit LU9 has its emitting surface facing the area A5.

In this embodiment as well, advantageous effects similar to those of the first embodiment can be achieved. In this embodiment, the light emitted by the light-emitting elements LS of the light source unit LU9 enters the area A5. With this configuration, the brightness in the area A5 is less likely to decrease.

As a result, the uniformity of brightness in the first portion 301 can be improved.

Based on the display devices described above as embodiments of the invention, a person having ordinary skill in the art may achieve display devices with arbitral design changes; however, as long as they fall within the scope and spirit of the present invention, all of such display devices are encompassed by the scope of the present invention. A skilled person would conceive various changes and modifications of the present invention within the scope of the technical concept of the invention, and naturally, such changes and modifications are encompassed by the scope of the present invention. For example, if a skilled person adds/deletes/alters a structural element or design to/from/in the above-described embodiments, or adds/deletes/alters a step or a condition to/from/in the above-described embodiment, as long as they fall within the scope and spirit of the present invention, such addition, deletion, and altercation are encompassed by the scope of the present invention.

Furthermore, regarding the embodiments, any advantage and effect those will be obvious from the description of the specification or arbitrarily conceived by a skilled person are naturally considered achievable by the present invention.

What is claimed is

1. A display device comprising a liquid crystal layer containing a polymer-dispersed liquid crystal, and switching between a first state in which light entering the liquid crystal layer is transmitted and a second state in which light entering the liquid crystal layer is scattered in accordance with a voltage applied to the liquid crystal layer, the display device comprising:
a display panel including a display area comprising a plurality of pixels;
a light guide overlaid on the display panel; and
a plurality of light-emitting elements which irradiating light to the light guide,
wherein
the light guide includes a first portion overlapping the display area and a second portion connected to the first portion,
some of the plurality of pixels are disposed in a matrix along a first direction and a second direction orthogonal to the first direction,
a width of the first portion along the first direction is greater than a width of the second portion along the first direction,
the second portion includes a first side surface extending in a first extending direction different from the first direction and the second direction, and a second side surface extending in a second extending direction different from the first extending direction in plan view, and
the plurality of light-emitting elements are disposed along the first side surface and the second side surface.

2. The display device of claim 1, wherein
the first portion includes an outer area provided on an outer side farther from the second portion in at least one of the first direction and a direction opposite to the first direction.

3. The display device of claim 2, wherein
the first portion includes the outer area in both the first direction and the opposite direction of the first direction.

4. The display device of claim 2, wherein
the outer area overlaps the display area.

5. The display device of claim 1, wherein
a width of the second portion along the first direction decreases as a location is further away from the first portion.

6. The display device of claim 1, wherein
the second portion further comprises a third side surface which connects the first side surface and the second side surface, and
the plurality of light-emitting elements include a first group of light-emitting elements disposed along the first side and the second side, and a second group of light-emitting elements disposed along the third side.

7. The display device of claim 6, wherein
the third side surface extends along the first direction.

8. The display device of claim 7, wherein
an angle made between the first side surface and the third side surface is equal to an angle made between the second side surface and the third side surface.

9. The display device of claim 8, wherein
the angle made between the first side surface and the third side surface, and the angle made between the second side surface and the third side surface are greater than 90 degrees and less than 180 degrees.

10. The display device of claim 1, wherein
a size of the display panel is equal to a size of the first portion.

11. The display device of claim 1, wherein
a size of the display panel is equal to a size of the light guide.

12. The display device of claim 1, wherein
the display panel has a circular shape in plan view.

13. The display device of claim 1, wherein
the display panel includes a curved portion in plan view.

14. The display device of claim 1, wherein
the liquid crystal layer contains polymers extending along the first direction and arranged to be spaced apart from each other along the second direction, and liquid crystal molecules disposed between the polymers, respectively.

15. A display device comprising:
a display panel including a display area comprising a plurality of pixels;
a substrate overlaid on the display panel, comprising a main surface and side surfaces intersecting the main surface, and having light transmittance; and
a plurality of light-emitting elements disposed along part of the side surfaces,
wherein
the substrate includes a non-overlapping area which does not overlap the display panel,
the part of the side surfaces includes a first side surface and a second side surface that are located in the non-overlapping area, and
a first extending direction in which the first side surface extends is different from a second extending direction in which the second side surface extends, in plan view.

16. The display device of claim 15, wherein
the first side surface intersects the second side surface.

17. The display device of claim 15, wherein
the plurality of light-emitting elements are disposed along the first side surface and the second side surface, and
side surfaces other than the first side surface and the second side surface, of the side surfaces, do not face the plurality of light-emitting elements.

18. The display device of claim 15, wherein
the first side surface is spaced apart from the second side surface,
the part of the side surfaces includes a third side surface located between the first side surface and the second side surface,
a direction in which the third side extends is different from the first extending direction and the second extending direction, and
the plurality of light-emitting elements are disposed along the first side surface, the second side surface, and the third side surface.
